(19) United States
(12) Patent Application Publication
(10) Pub. No.: US 2015/0172705 A1
(43) Pub. Date: Jun. 18, 2015

(54) WINDOW DETECTION DEVICE AND METHOD ON MULTI-MEDIA SYSTEM

(71) Applicant: Realtek Semiconductor Corp., Hsinchu (TW)

(72) Inventors: Jen-Chieh LEE, TAI NAN CITY (TW); I-Hsiu LO, CHIEH LUNG CITY (TW)

(21) Appl. No.: 14/564,841

(22) Filed: Dec. 9, 2014

(30) Foreign Application Priority Data
Dec. 13, 2013 (TW) 102146193

(51) Int. Cl. H04N 19/57; H04N 19/513

(52) U.S. Cl. CPC H04N 19/57; H04N 19/521

(57) ABSTRACT

A window detection device and method on multi-media system is disclosed in the present invention. The window detection device includes a sampling unit, a frame buffer, a motion detector and an edge detector. The sampling unit samples an image from a frame source to generate a sampled frame. The frame buffer stores the sampled frame. The motion detector compares a previous sampled frame stored in the frame buffer and an upcoming current sampled frame to find out a difference between the previous sampled frame and the current sampled frame so as to determine a motion area of the image. The edge detector receives the motion area and enhances edges of the motion area. Further the edge detector detects the enhanced motion area to generate high frequency edges. The window detection device determines a motion image windows area according to the high frequency edges.

This application claims the benefit of the filing date of Taiwan Application Ser. No. TW102146193, filed on 2013 Dec. 13, the content of which is incorporated herein by reference.

### BACKGROUND OF THE INVENTION

1. Field of the Invention

The invention relates to electronic devices, and more particularly, to a window detection device and method on a multi-media system.

2. Description of the Related Art

As shown in FIG. 1, generally a display 100 performs some special effects on output signals, such as multi-media processing like image contrast enhancement, color space conversion, etc. In the frame 101 of the display, various dynamic objects are spotlights to users, such as multi-media videos now playing or repeatedly shown motion pictures.

However, generally a motion area requires being processed by a system resource in order to achieve better display quality but a traditional display allocates the same resource to a non-dynamic area as a dynamic area during processing and cannot real-time detect dynamic objects. Therefore, computing resources will be wasted on the non-dynamic area and cannot optimize image quality for the dynamic area 102 to thereby fail to enhance display quality.

### SUMMARY OF THE INVENTION

On objective of the present invention is to improve the above mentioned problems of the prior art. The window detection device and method on a multi-media system according to the present invention can detect an image to select a specific windows area, such as a motion image windows area, for subsequently processing a preset area of the image. The present area is the spotlight of users, for example, a multi-media playing area while viewing a movie. That is, such an area can be selected for being enhanced by the system.

According to one embodiment of the present invention, a window detection device on a multi-media system is provided. The window detection device includes a sampling unit, a frame buffer, a motion detector and an edge detector. The sampling unit receives an image of a frame source and samples the frame of the image to generate a sampled frame. The frame buffer stores the sampled frame. The motion detector compares a previous sampled frame stored in the frame buffer and a current sampled frame to find out a difference between the previous sampled frame and the current sampled frame, so as to determine a motion area of the image. The edge detector receives the motion area and performs an edge-enhancing on the motion area. Further the edge detector detects the enhanced motion area after the edge enhancing, so as to generate high frequency edges. The window detection device determines a motion image windows area according to the high frequency edges.

According to another embodiment of the present invention, a window detection method on a multi-media system is provided. The window detection method includes the following steps. At first, an image of a frame source is received and sampled to generate a sampled frame. The sampled frame is stored. Then, a previous sampled frame and a current sampled frame are compared to find out a difference between the previous sampled frame and the current sampled frame so as to determine a motion area of the image. Then, the motion area is received, edges of the motion area are enhanced by performing an edge-enhancing on the motion area, and an enhanced motion area after the edge-enhancing is detected to generate high frequency edges. Finally, a motion image windows area is determined according to the high frequency edges.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram illustrating a display according to the prior art.

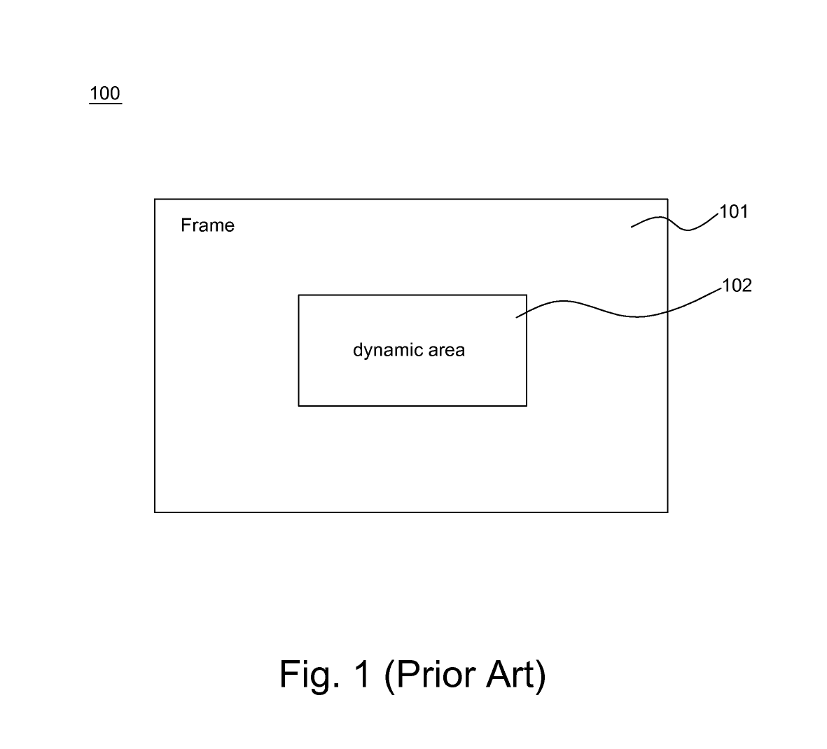

FIG. 2 shows a schematic diagram illustrating a window detection device on a multi-media system according to an embodiment of the invention.

FIG. 3 shows a schematic diagram illustrating the height of the sampled frame reduced to the original height/M and the width of the sampled frame reduced the original width/N generated by the sampling unit according to an embodiment of the invention.

FIG. 4 shows a schematic diagram illustrating that a noise eliminator maps the motion area to X and Y axes according to an embodiment of the invention.

FIG. 5 shows a schematic diagram illustrating edge detection on an image by an edge detector according to an embodiment of the invention.

FIG. 6 shows a schematic diagram illustrating that an adaptive spatial filter determines high frequency edges of a frame to perform superimposing according to an embodiment of the invention.

FIG. 7 shows a flow chart of a window detection method on a multi-media system according to an embodiment of the invention.

### DETAILED DESCRIPTION OF THE INVENTION

In this specification and the appended claims, some specific words are used to describe specific elements. It should be understood by those who are skilled in the art that some hardware manufacturer may use different names to indicate the same element. In this specification and the appended claims, elements are not differentiated by their names but their functions. As used herein and in the claims, the term “comprising” is inclusive or open-ended and does not exclude additional unrecited elements, compositional components, or method steps. Besides, the term “coupling”, when used herein and in the claims, refers to any direct or indirect connection means. Thus, if the specification describes a first device is coupled to a second device, it indicates that the first device can be directly connected (via signal connection, including electrical connection, wireless transmission, optical transmission, etc.) to the second device, or be indirectly connected to the second device via another device or connection means.

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context.

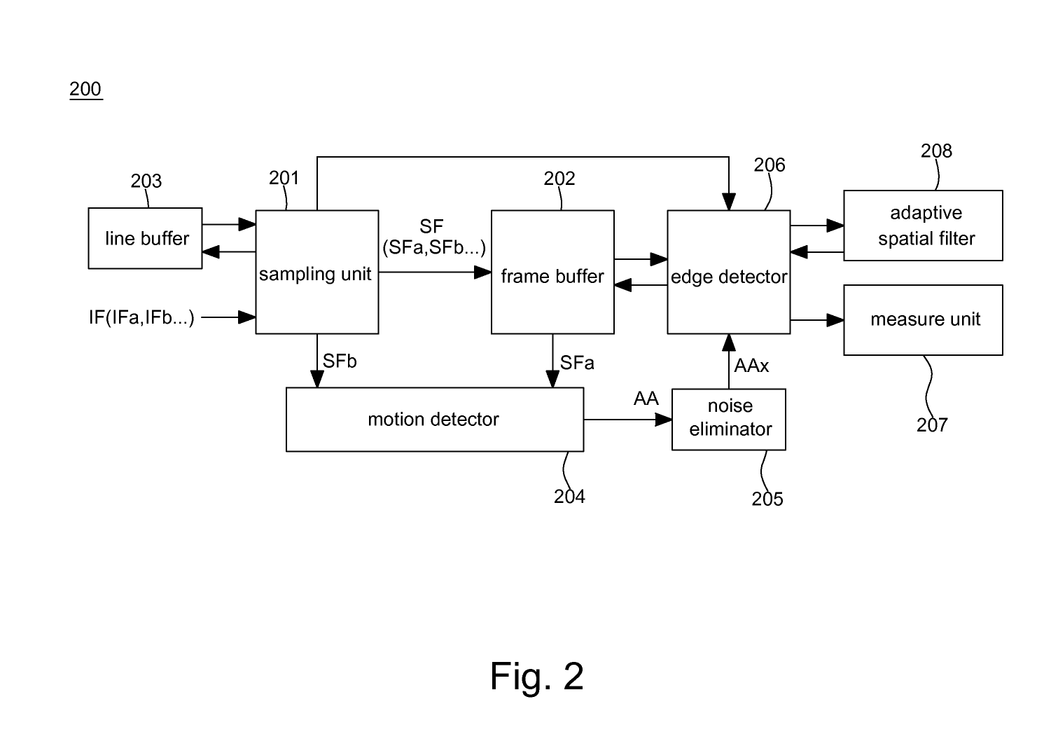

FIG. 2 shows a schematic diagram illustrating a window detection device on a multi-media system according to an embodiment of the invention. The window detection device 200 includes a sampling unit 201, a frame buffer 202, a line buffer 203, a motion detector 204, a noise eliminator 205, an edge detector 206, a measure unit 207, and an adaptive spatial filter 208.

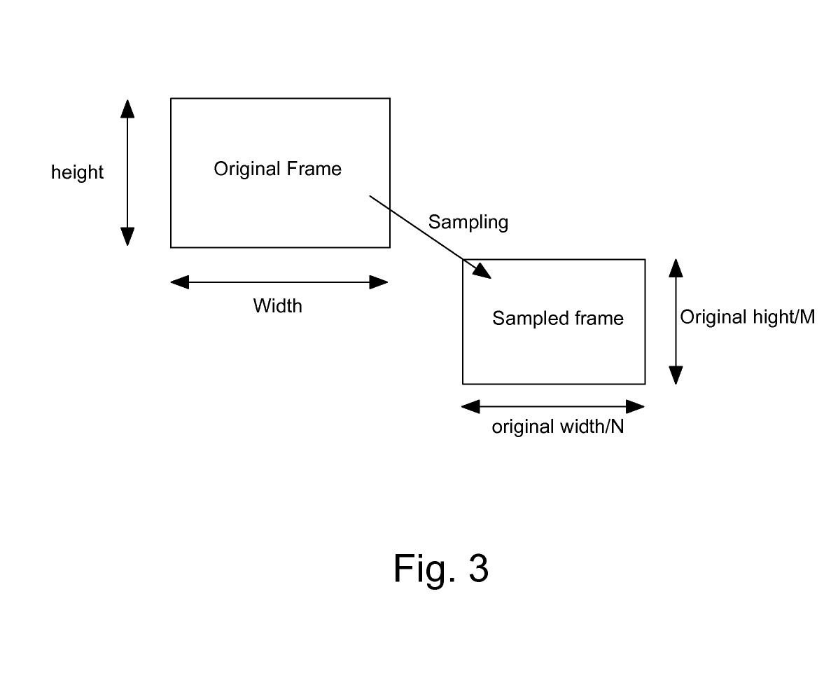

The sampling unit 201 receives an image of a frame source IF and samples the frame of the image to generate a sampled frame. In one embodiment, the frame source IF is a terminal input such as any current input source or any future to-be-developed input source like HDMI (High Definition Multimedia Interface), display port, Dsub, cables, etc. When the received image is larger, the sampling unit 201 processes the frame of the image by downing sampling to reduce hardware cost. The height of the sampled frame generated by the sampling unit 201 is reduced to the original height /M and the width is reduced to the original width/N where M and N are natural numbers less than infinity, preferably a positive integer as shown in FIG. 3.

The frame buffer 202 stores the sampled frame SF. In one embodiment, the frame buffer 202 is a storage unit such as DRAM (Dynamic Random Access Memory) or SRAM (Static Random Access Memory).

Regarding the line buffer 203, during the process the sampling unit 201 samples the frame IF of the image, the sampling unit 201 repeatedly accumulates pixel data of a whole column in the frame IF and stores pixel data in the line buffer 203.

The motion detector 204 is used to compare a previous sampled frame SFa stored in the frame buffer 201 and a current sampled frame SFb to search for a difference between the previous sampled frame SFa and the current sampled frame SFb so as to determine an area having more motion to generate a motion area AA of the image. In one embodiment, after sampling two adjacent frames SFa and SFb in time sequence, the motion detector 204 compares the previous sampled frame SFa and the current sampled frame SFb and performs a calculation process on pixels corresponding to the previous sampled frame SFa and the current sampled frame SFb. For example, calculating an absolute difference (or subtraction or exclusive OR) is executed to acquire the difference between the two frames. Then, the difference is used to find an area having more motion so as to generate the motion area AA of the image. The newer frame SFb in the two adjacent frames is real-time sampled by the sampling unit 201 and the older frame SFa is taken from the frame buffer 202. Specifically, the previous frame IFa is downing sampled and stored as the previous sampled frame SFa and then the previous unsampled frame IFa is replaced when the following frame IFb comes in. Therefore, the window detection device 200 only requires a buffer capacity for one frame to reduce product cost.

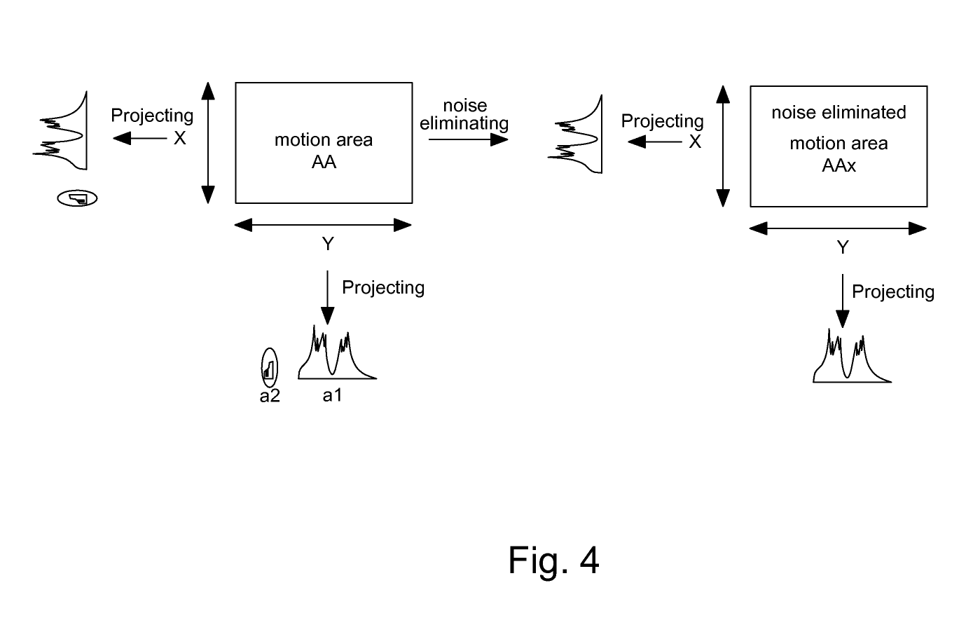

The noise eliminator 205 receives the motion area AA, maps the motion area AA to X and Y axes to generate an accumulated histogram and eliminates content corresponding to a value less than a preset value in the accumulated histogram from the motion area AA so as to output a noise eliminated motion area AAx. The noise can be a dynamic object which is not content of a multimedia player, such as a mouse cursor, small taskbar drawings, etc. In order to assure that the result after dynamic detection is not influenced by these noises, the noise eliminator 205 is used to eliminate these noises. In one embodiment, as shown in FIG. 4, the noise eliminator 205 maps the motion area AA to X and Y axes and forms accumulated histograms for X axis and Y axis, separately. In FIG. 4, taking Y axis as one example, the histogram can be divided into two area a1 and a2 where the smaller one a2 is of noise, such as a moving mouse cursor. Then, the noise eliminator 205 eliminates the value (noise) a2 less than a present value from the motion area AA to generate the noise eliminated motion area AAx.

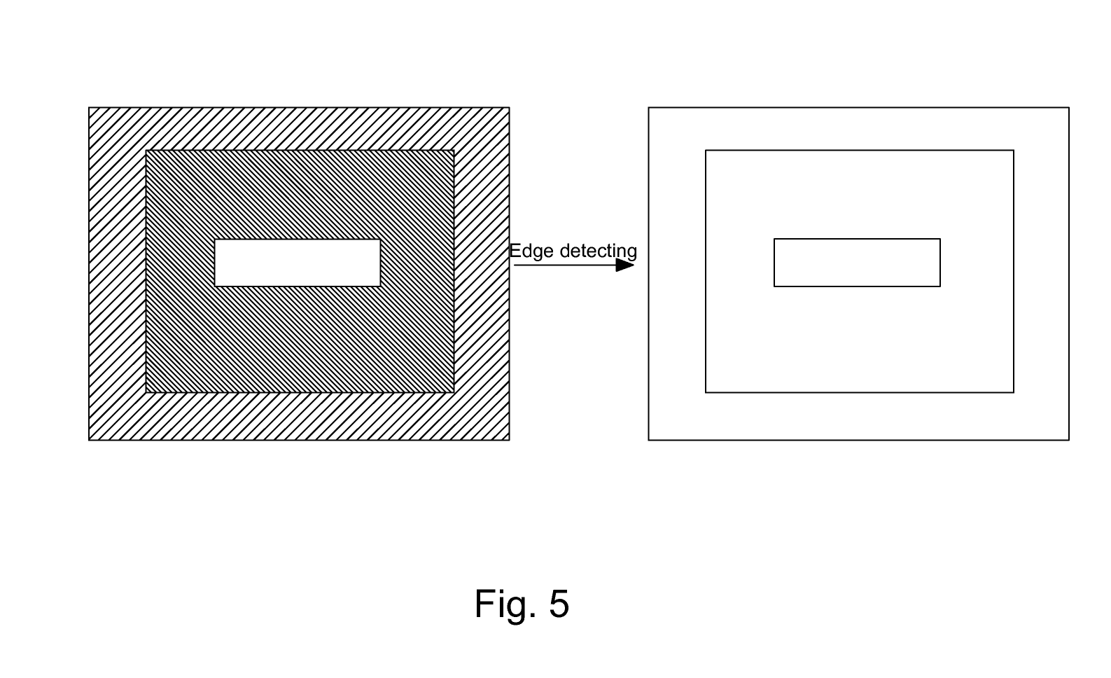

The edge detector 206 receives the noise eliminated motion area AAx and generates edges AE of the motion area according to the noise eliminated motion area AAx. It should be noted that in one embodiment the edge detector 206 can receive the motion area AA not going through the noise eliminator 205 and generate edges AE of the motion area. As the noise eliminated motion area AAx is taken as an example, the edge detector 206 detects edges according to the noise eliminated motion area AAx to generate data of the multi-media playing frame and enhances the image based on the knowledge of data of the frame of the noise eliminated motion area AAx to detect high frequency edges from the center of the image toward outside. The edge detector 206 determines whether edges are connected to form a rectangular frame or not and generates edges AE of the motion area containing only high frequency edges after processing. In one embodiment, as shown in FIG. 5, the edge detector 206 detects edges of the image (drawing on the left hand side) accompanying with the process of the line buffer 203 to take two line of the frame of the image for frame detection so as to recognize data of X and Y axes to find out frame lines to generate a portion of high frequency edges in the frame (drawing on the right hand side). The portion of high frequency edges is for example frame lines of a multimedia player, called “multimedia frame” hereinafter.

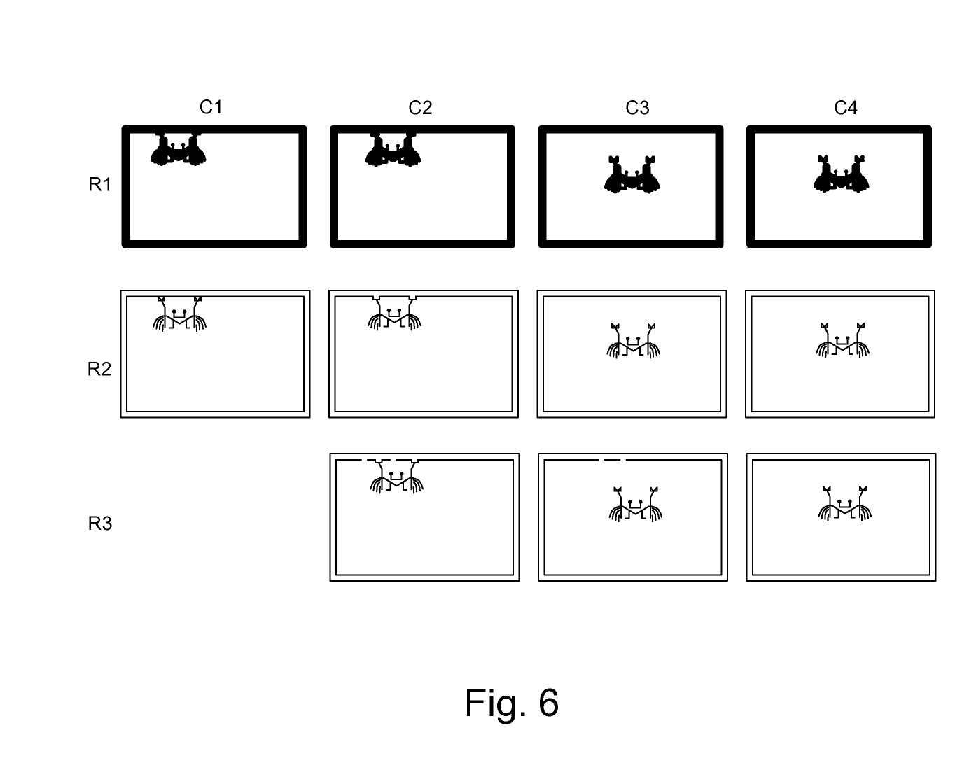

The adaptive spatial filter 208 receives high frequency edges of each frame, finds out boundary areas of the high frequency edges of each frame and combines the boundary areas by mutually superimposing so as to generate a complete boundary in order to generate data of continuous playing frames. For example, generally the detection result of the edge detector 206 is a multimedia playing frame. Since the content of the multimedia playing frame is close to background colors in the image (or screen), it is difficult to detect the edges to result in intermittently showing the multimedia playing frame. The adaptive spatial filter 208 determines which areas are needed to be superimposed in the high frequency edges of the frame and determines the levels of superimposing. It should be noted that the adaptive spatial filter 208 avoids that the result of excessively superimposing high frequency edges affects the correctness of the measurement subsequently done by the measure unit 207. As shown in FIG. 6, the first row R1 shows input image frames, the second row R2 shows high frequency edges generated by the edge detector 206 after edge detection and the third row R3 shows the results of filtering processing by the adaptive spatial filter 208. As shown in the figure, the third row and third column (R3, C3) records the difference between the second row and second column (R2, C2) and the second row and third column (R2, C3). Because the edge portion of the difference is close to background color, the image after edge detection has broken edges. Then, after processed by superimposing combination by the adaptive spatial filter 208, in the third row R3, the portion of broken edges is slowly repaired over time until becoming a complete segment.

The measure unit 207 is used to find out whether segments of the high frequency edges are mutually connected to form a rectangle. In one embodiment of the way of searching, pixels of the high frequency edges are searched one by one. In another embodiment, when data amount of image superimposing processed by the adaptive spatial filter 208 is enough to form a complete rectangle, the measure unit 207 measures the horizontal line of the rectangle frame and then measures from the two ends of the rectangle to check if there is a complete rectangle and repeatedly check the whole frame. After measured by the measure unit 207, if a complete rectangle is actually detected, coordinates of four vertices of the rectangle will be found. Based on these coordinates, the system can allocate more resources on content in the area within the coordinates to perform various image processes or enhancement such as color, brightness, chroma, sharpness or contrast enhancement processes.

In one embodiment, the measure unit searches for edge frame lines from the portion having more motion in the motion area towards outside and determines the current image or screen has a multimedia playing frame only when an enclosed area is large enough to reach preset size. It should be noted that the above frame lines of the rectangle is due to the current display method. Mostly, the image playing block is a rectangle. Therefore, the continuous frame line areas processed by the window detection device on a multimedia system according embodiments of the present invention are not limited to rectangles. The continuous frame line areas with various shapes, such as circular, elliptical or 3D playing blocks, are applicable.

Furthermore, in one embodiment, when the image is static for a certain period of time, the window detection device on a multimedia system according embodiments of the present invention can switch the dynamic image processing to static image processing. For example, the functions of selecting a motion area and providing more resources in this embodiment is paused or canceled. When the image includes a dynamic image, the window detection device on a multimedia system according embodiments of the present invention detects it and switches back to provide the function for a dynamic image.

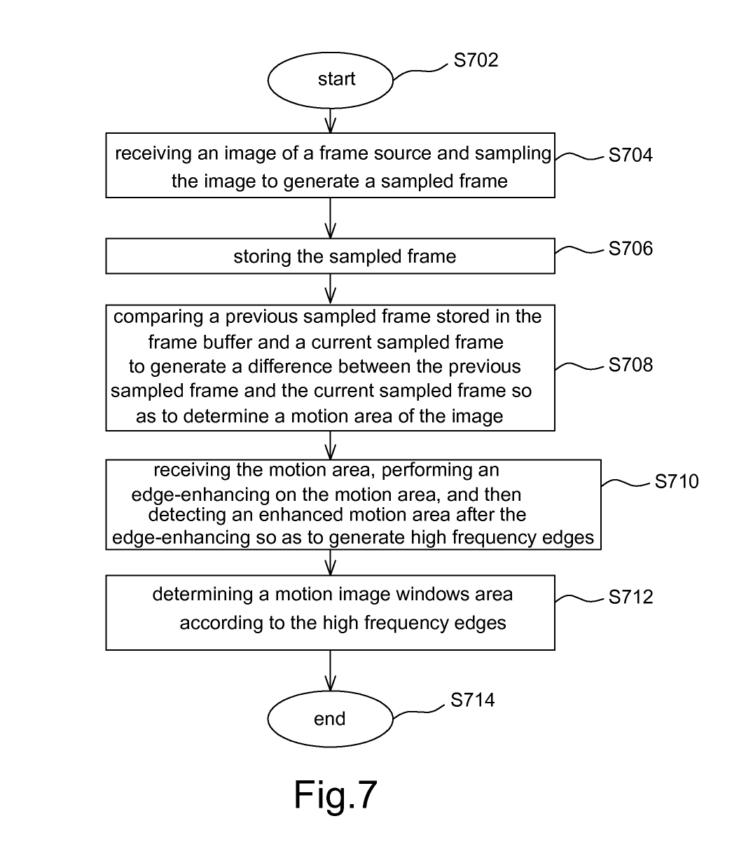

FIG. 7 shows a flow chart of a window detection method on a multi-media system according to an embodiment of the invention. The method includes the following steps:

Step S702: start;

Step S704: receiving an image of a frame source and sampling the image to generate a sampled frame;

Step S706: storing the sampled frame;

Step S708: comparing a previous sampled frame stored in the frame buffer and a current sampled frame to generate a difference between the previous sampled frame and the current sampled frame so as to determine a motion area of the image;

Step S710: receiving the motion area, performing an edge-enhancing on the motion area, and then detecting an enhanced motion area after the edge-enhancing so as to generate high frequency edges;

Step S712: determining a motion image windows area according to the high frequency edges;

Step S714: end.

The other steps of the method according to the claims of the present invention can be understood from the description of the above device and their details are not given hereinafter.

In conclusion, the window detection device on a multi-media system according embodiments of the present invention correctly finds out a motion area in an image to have the system provide more resources on the motion area for enhancement to enhance image display quality so as to solve the problems in the prior art.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A window detection device on a multi-media system, comprising:
a sampling unit, sampling a frame of an image to generate a sampled frame;
a frame buffer, storing the sampled frame;
a motion detector, comparing a previous sampled frame stored in the frame buffer and a current sampled frame to find out a difference between the previous sampled frame and the current sampled frame, so as to determine a motion area of the image; and
an edge detector, performing an edge-enhancing on the motion area and then detecting an enhanced motion area after the edge-enhancing, so as to generate high frequency edges;
wherein the window detection device determines a motion image windows area according to the high frequency edges.

2. The window detection device according to claim 1, further comprising:
a line buffer, storing pixel data of the frame accumulated while the sampling unit samples the frame of the image.

3. The window detection device according to claim 1, wherein the motion detector executes a calculation process on pixels corresponding to the previous sampled frame and the current sampled frame to find out the difference.

4. The window detection device according to claim 3, wherein the calculation process includes at least one process selected from the group consisting of the following: absolute value calculation, subtraction calculation and exclusive OR calculation.

5. The window detection device according to claim 1, wherein the frame buffer has a storage capacity to store a frame.

6. The window detection device according to claim 1, further comprising:
a noise eliminator, eliminating dynamic objects which are not content of a multi-media player in the motion area.

7. The window detection device according to claim 6, wherein the noise eliminator receives the motion area, maps the motion area to X and Y axes to generate an accumulated histogram and eliminates content corresponding to a value less than a preset value in the accumulated histogram.

8. The window detection device according to claim 2, wherein the edge detector uses the line buffer to take two lines of the image of the motion area and acquires data of X and Y axes of the motion area so as to generate the high frequency edges of the motion area, while detecting edges.

9. The window detection device according to claim 1, further comprising: an adaptive spatial filter, receiving high frequency edges of each frame, finding out boundary areas for the high frequency edges of each frame and combining the boundary areas by mutually superimposing so as to generate a complete boundary.

10. The window detection device according to claim 1, further comprising: a measure unit, receiving the high frequency edges and determining whether segments of the high frequency edges are mutually connected to a continuous frame line area or not so as to determine the motion image windows area.

11. A window detection method on a multi-media system, comprising:
receiving an image of a frame source and sampling a frame of the image to generate a sampled frame;
storing the sampled frame;
comparing a previous sampled frame and a current sampled frame to find out a difference between the previous sampled frame and the current sampled frame so as to determine a motion area of the image;
receiving the motion area, performing an edge-enhancing on the motion area, and then detecting an enhanced motion area after the edge-enhancing so as to generate high frequency edges; and
determining a motion image windows area according to the high frequency edges.

12. The window detection method according to claim 11, wherein the difference is found out by a calculation process on pixels corresponding to the previous sampled frame and the current sampled frame.

13. The window detection method according to claim 12, wherein the calculation process includes at least one process selected from the group consisting of the following: absolute value calculation, subtraction calculation and exclusive OR calculation.

14. The window detection method according to claim 11, further comprising: eliminating dynamic objects which are not content of a multi-media player in the motion area.

15. The window detection method according to claim 14, wherein the step of eliminating dynamic objects which are not content of a multi-media player in the motion area comprises: receiving the motion area, mapping the motion area to X and Y axes to generate an accumulated histogram and eliminating content corresponding to a value less than a preset value in the accumulated histogram.

16. The window detection method according to claim 11, wherein the step of generating high frequency edges comprises: using a line buffer to take two lines of the image of the motion area and acquiring data of X and Y axes of the motion area so as to generate the high frequency edges of the motion area.

17. The window detection method according to claim 11, further comprising: an adaptive spatial filtering step including receiving high frequency edges of each frame, finding out boundary areas for the high frequency edges of each frame and combining the boundary areas by mutually superimposing so as to generate a complete boundary.

18. The window detection method according to claim 11, further comprising: a measurement step including receiving the high frequency edges and determining whether segments of the high frequency edges are mutually connected to a continuous frame line area or not so as to determine the motion image windows area.
